(19) United States
(12) Patent Application Publication
(10) Pub. No.: US 2003/0039333 A1
(43) Pub. Date: Feb. 27, 2003

(54) Method for determining an x-ray dose

(76) Inventors: Magnus Houska, Modling (AT); Detlef Hofmann, Erlangen (DE)

Correspondence Address: YOUNG & THOMPSON, 745 SOUTH 23RD STREET 2ND FLOOR, ARLINGTON, VA, 22202

(21) Appl. No.: 10/207,117

(22) Filed: Jul. 30, 2002

(30) Foreign Application Priority Data
Jul. 30, 2001 (DE) 101 37 245.0

(51) Int. Cl. H05G 1/42

(52) U.S. Cl. 378/97

(57) ABSTRACT

The invention relates to methods for determining an X-ray dose, to which a living organism is exposed because of examination with the aid of an X-ray machine, from a data record that is assigned to an X-ray image produced during the examination. The data record comprises image data assigned to the X-ray image and data suitable for determining the X-ray dose.

The invention relates to a method for determining an X-ray dose to which a living organism is exposed because of examination with the aid of an X-ray machine.

When an X-ray image is being taken, a patient under examination with the aid of an X-ray machine is exposed to an X-ray dose determined by the X-ray image and the X-ray machine. In accordance with section 28(2) RoV (X-ray regulation), an operator of an X-ray machine must record each application of X-ray beams. The records must show the time, the type of application, the body region examined or treated, and data that are required for determining the X-ray dose. The records are to be submitted upon demand from the relevant authority.

An administration, in particular of a hospital with a large radiological department, must therefore create and keep many such records. The object of the invention is therefore to specify a method that creates a precondition determining the X-ray dose on the basis of an X-ray examination in a simple way.

The object of the invention is achieved by means of a method for determining an X-ray dose to which a living organism is exposed because of examination with the aid of an X-ray machine, from a data record that is assigned to an X-ray image produced during the examination, the data record comprising image data assigned to the actual X-ray image and data suitable for determining the X-ray dose, having the following method steps:

extracting from the data record the data suitable for determining the X-ray dose, and

determining the X-ray dose on the basis of the data suitable for determining the X-ray dose.

X-ray images are increasingly present in digitized form so that, for example, they can be stored in a database or transferred via an information transfer network. In addition to the image data assigned to the actual X-ray image that are intended for visualizing the X-ray image, for example with the aid of a display device of a computer, the data record assigned to the X-ray image usually also has data comprising information on the production of the X-ray image. These data comprise, for example, details on a setting of the X-ray machine during the examination, on the type of the X-ray machine, etc. These data can be used in a generally known way to calculate the X-ray dose. These data are thus extracted according to the invention from the data record in order to determine the X-ray dose on the basis of these data. The extraction of the data and the subsequent determination of the X-ray dose can preferably be undertaken in an automated way, as a result of which, for example, a radiologist carrying out the X-ray examination need not calculate and document the X-ray dose. The method according to the invention also permits subsequent determination of the X-ray dose.

If, in accordance with one embodiment of the invention, after being determined the X-ray dose is archived automatically, for example in a suitable database, this results in a further saving of time for the radiologist.

In medical technology, images, that is to say also X-ray images, are generally encoded according to the DICOM (Digital Imaging and Communication in Medicine) Standard. A particularly preferred embodiment of the invention therefore provides coding the data record in accordance with the DICOM Standard.

The DICOM data structure has a list of data elements, so called attributes, that, in addition to the actual image information (image data), also comprise the identity of the patient assigned to the X-ray image and the relevent information for determining the X-ray dose. These data are stored in a so-called header (compare Heinz Morneburg (Ed.) “Bildgebende Systeme für die medizinische Diagnostik” [“Imaging systems for medical diagnostics”], 3rd Edition, Publicis MCD Verlag, Erlangen, 1995, page 686).

According to further embodiments of the invention, the data record is transferred to a central computer, in particular via an information transfer network. It is thereby possible for X-ray doses of different patients to be determined and archived centrally. The X-ray doses can thereby also be statistically evaluated in a simple way, for example for protecting buildings against radiation.

An illustrative embodiment of the invention is illustrated by way of example in the schematic drawings, in which:

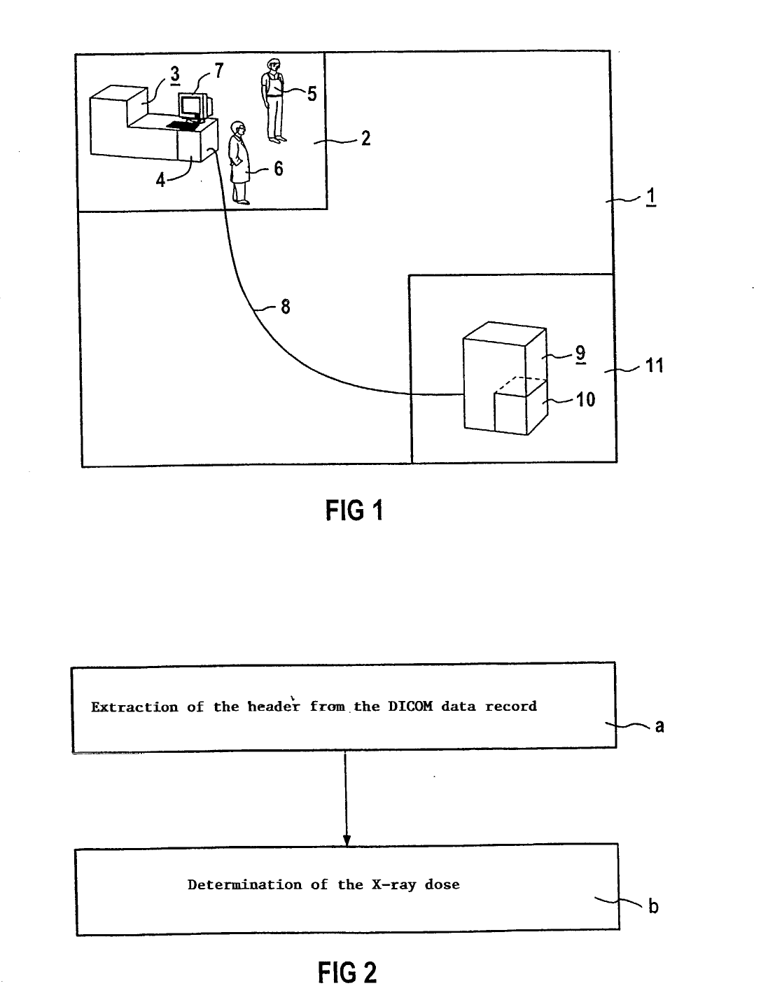

FIG. 1 shows a hospital and

FIG. 2 shows a flowchart illustrating the method according to the invention.

FIG. 1 shows a hospital 1 with a radiological department 2 in which an X-ray machine 3 is located. In the case of the present exemplary embodiment, the X-ray machine 3 comprises a computer 4 that controls the X-ray machine 4 in a known way during examination of a patient 5. Furthermore, a computer program stored in the computer 4 creates a data record according to the DICOM Standard during the examination of the patient 5. The data record therefore comprises both image data that are assigned to an X-ray image produced with the aid of the X-ray machine 3, and further data that comprise, in particular, information on the identity of the patient 5 and settings of the X-ray machine 3. These data are stored in a so-called header.

After the data record has been picked up by the X-ray machine 3, a radiologist 6 carrying out the examination of the patient 5 can use the X-ray image produced with the aid of the X-ray machine 3 by means of a monitor 7 connected to the computer 4 of the X-ray machine 3. Moreover, in the case of the present exemplary embodiment the data record assigned to the X-ray image is automatically transferred via a hospital information transfer network 8 to a central computer 9 in which the data record is archived in a database 10 of the central computer 9. In the case of the present exemplary embodiment, the central computer 9 is located in an administration room 11 of the hospital 1.

Also stored in the central computer 9 is a suitable computer program that automatically copies the data record transferred to the central computer 9 and encoded according to the DICOM Standard. Subsequently, the computer program suitably extracts the header from the copied data record (step a of the flowchart illustrated in FIG. 2).

In addition to information on the identity of the patient 5, the header also comprises information on the setting of the X-ray machine 3 during the examination of the patient 5. The details on the setting of the X-ray machine 3 comprise, inter alia, the recording time, the quantity of electricity set and the X-ray tube voltage so that the computer program can determine the X-ray dose in a suitable way (step b of the flowchart illustrated in FIG. 2).

Subsequently, the computer program automatically deletes the copied data record and stores the determined X-ray dose with the identity of the patient 5 in the database 10 of the central computer 9.

In addition to the X-ray dose and the identity of the patient 5, it is also possible for the database 10 of the central computer 9 to store further information held by the header of the DICOM data record.

Furthermore, the computer program stored in the central computer 9 is preferably designed in such a way that when calculating the X-ray dose it also takes account of an overlap owing to a spiral recording of a computer tomograph.

The method according to the invention does not necessarily require a data record according to the DICOM Standard to be present. It is also possible to use other standards as long as the data record has data from which an X-ray dose can be determined.

The method according to the invention can also be used outside a hospital. Transferring the data record via an information transfer network is also optional.

1. A method for determining an X-ray dose, to which a living organism is exposed because of examination with the aid of an X-ray machine, from a data record that is assigned to an X-ray image produced during the examination, the data record comprising image data assigned to the actual X-ray image and data suitable for determining the X-ray dose, having the following method steps:
extracting from the data record the data suitable for determining the X-ray dose, and
determining the X-ray dose on the basis of the data suitable for determining the X-ray dose.

2. The method as claimed in claim 1, in which the determined X-ray dose is automatically stored in a database.

3. The method as claimed in claim 1 or 2, in which the database is coded according to the “Digital Imaging and Communication in Medicine” (DICOM) Standard.

4. The method as claimed in claim 1, in which the data record is transferred to a central computer.

5. The method as claimed in claim 4, in which the data record is transferred via an information transfer network.

6. A method for determining an X-ray dose, having the following method steps:
using an X-ray machine to produce a data record that comprises image data, which are assigned to an X-ray image produced during an examination of a living organism with the aid of the X-ray machine, and suitable data for determining the X-ray dose to which the living organism is exposed because of the production of the X-ray image,
extracting the suitable data from the data record, and
determining the X-ray dose on the basis of the suitable data.

7. The method as claimed in claim 6, in which the determined X-ray dose is automatically stored in a database.

8. The method as claimed in claim 6 or 7, in which the data record is coded according to the “Digital Imaging and Communication in Medicine” (DICOM) Standard.

9. The method as claimed in claim 1, in which the data record is transferred to a central computer.

10. The method as claimed in claim 9, in which the data record is transferred via an information transfer network.
